(19) United States
(12) Patent Application Publication
(10) Pub. No.: US 2011/0179478 A1
(43) Pub. Date: Jul. 21, 2011

(54) Method for secure transmission of sensitive data utilizing network communications and for one time passcode and multi-factor authentication

(76) Inventor: Matthew Edward Flick, (US)

(21) Appl. No.: 12/987,091

(22) Filed: Jan. 8, 2011

Related U.S. Application Data
(60) Provisional application No. 61/295,208, filed on Jan. 15, 2010.

(51) Int. Cl. H04L 9/32

(52) U.S. Cl. 726/9

(57) ABSTRACT

The invention is directed to a secure data transmission system and method for use in connection with potentially untrusted computer systems and data communication networks. The method involves transmission of sensitive data, such as authentication credentials, between at least two entities (for example, client and server systems and zero or more trusted token systems). This method utilizes symmetric encryption, shared secrets, and data strings composed of pseudo-random characters (also known as “tokens”) to authenticate entities to other entities and to securely transmit data between entities.

### CROSS-REFERENCE TO RELATED APPLICATIONS

This patent application is a continuation of the following provisional utility patent application:
Application No. 61/295,208
Filing or 371(c) Date: Jan. 15, 2010
Confirmation Number: 2570
Filing Receipt Serial Number: OC000000039862166
Applicant(s): Same as applicant listed in “INVENTOR” section of this specification
Title: Method for securely transmitting sensitive data utilizing network communications

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The transmission of data between two entities is typically vulnerable to unauthorized viewing by means of data capture techniques. Data protection protocols, such as Secure Socket Layer (SSL) and Transport Layer Security (TLS), utilize encryption algorithms and may be used as a supplement to unprotected communications protocols in order to enable both the sending and receiving entities to protect the data transmissions against such unauthorized data capture attacks. Reliance on such protocols has become widespread and typically presents a single point of failure with regards to protecting data confidentiality. Additionally, these protocols have been shown to be vulnerable to other types of attacks that may allow attackers or malicious users to obtain unauthorized access to sensitive data.

Entities utilize many applications to share or transmit data between them. Currently, these applications may be implemented as three different types: 1. client-server; 2. client-client (also referred to as “peer-to-peer”); and 3. server-server (also referred to as “business-to-business”). This invention may apply to all types of applications for which an authentication method is utilized to identify the identity of any two entities utilizing said application. For illustration purposes, the diagrams and example processes included in the specification of this invention will incorporate a client-server application.

Applications (or any type of system) may utilize an authentication method to enable one entity to validate the identity of another entity. The most common authentication method involves a pair of data values known to each entity, commonly referred to as “authentication credentials”, “login credentials”, or “user credentials”; for example, a user identification code and a shared secret (also known as a “token”). Shared secrets often take the form of a string of characters and are referred to as passwords or passphrases. Despite being a popular choice for authentication, this method of validating the identity of a client user has been known to be vulnerable to several types of attack, including man-in-the-middle and brute force credential guessing (both online and offline attacks).

Several methods have been created to defend against these attacks and strengthen the security of authentication credentials to increase the difficulty of obtaining unauthorized access to systems. Such methods include multi-factor authentication (“MFA”), which requires users to submit at least two distinct types of authentication tokens. MFA commonly utilizes two of the following three factors:
1. Something the user knows (e.g. password or passphrase)
2. Something the user possesses (e.g. bar code)
3. Something unique to the user's being (e.g. fingerprint)
   MFA methods increase the difficulty of gaining unauthorized access to the application by compromising a user's login credentials, but they suffer from various implementation issues that may either significantly increase the difficulty of implementation or provide minimal protection against known attacks, or both.

Multi-factor authentication methods that utilize one time passwords (“OTP”) employ mathematical algorithms to generate pseudo-random tokens (strings of characters) that must be validated along with a user identification value (“user id”) and optionally a shared secret. These OTP implementations require at least two components: a physical device or software application that calculates a new OTP token for one entity to transmit to the application, and a server system or software application that produces the same OTP token for the application to perform a comparison. Such OTP methods suffer from potentially significant logistical and technical drawbacks and can require human intervention when errors occur, such as de-synchronization between the physical device and server system.

Other types of OTP authentication methods that do not require users to have physical devices often require the user to engage in a challenge-response test or submit another variation of a shared secret in lieu of or along with typical login credentials. Although these types of OTP authentication methods does not suffer from the same logistical drawbacks, they are still vulnerable to common attack types such as man-in-the-middle, timing, and brute force that may allow an attacker to obtain unauthorized access to the application or compromise users' login credentials. Variations of these and other publicly known OTP authentication methods may improve usability but provide little or no improvements in protecting user credentials or preventing unauthorized access to the application.

### BRIEF SUMMARY OF THE INVENTION

The invention describes a new method for secure data transmission (“SDT”) one time password and multi-factor authentication that enables protection of data and identity validation. The invention provides similar benefits to traditional OTP and MFA methods without the associated drawbacks mentioned above. The new method of this invention can provide—to existing and future systems and applications—the ability to utilize a pseudo-random, one time encryption key for an encryption algorithm. The new method also provides protection against the common attacks that current authentication methods—with or without OTP or MFA—do not provide. The new method may utilize existing software instead of physical devices in order to deliver the pseudo-random token to an entity. Certain types of applications, such as web browsers, can be dynamically provided the required software (in the form of script or compilable code); other systems or software may need to be modified in order to perform the necessary functions to implement the new method. This new method may optionally be fully automated such that an entity, such as a human user, is unaware of any change to the underlying data transmissions (dependent on software and hardware limitations).

As mentioned above, the invention provides additional protection against online brute force attacks and other types of attacks that can be effective against other data protection and authentication methods. Since the trusted token server—as described in the claims—sends similar responses to new token requests from an entity (such as clients), an attacker cannot determine valid credentials from invalid ones based solely on the response from the trusted token server. Additionally, the invention enables entities to require storage of an initialization token that can prevent unauthorized access to a system even if an attacker is able to determine the shared secret. Other controls may optionally be implemented to further decrease the likelihood of a successful attack, such as assigning a time limit to the validity of new tokens for each entity, restricting the number of outstanding tokens for each entity, applying a hashing algorithm to shared secrets before using them in encryption functions, and limiting the number of new token requests from a single location or system for each entity. These optional controls are related to the invention but are not part of the invention or necessary for implementation of the invention.

In certain implementations, the method of the invention could prevent man-in-the-middle attacks. The invention allows for authentication of any single entity to another entity, including bi-directional authentication. In such implementations, two entities would prove their own identity to each other and verify the identity of the other entity. For example, in a client-server scenario, both the client system and server system would use a common shared secret to encrypt different pseudo-random data values to initiate authentication for each other. If another malicious entity attempted to spoof the identity of either or both of the client system and server system, the malicious entity would not be able to properly decrypt the ciphertext—as described in the invention—and therefore the client system and server system could discontinue communication with the malicious entity. It should be noted that this type of implementation would require the client system to store a unique shared secret for the server system, which is not a common practice in current environments.

### BRIEF DESCRIPTION OF THE SEVERAL VIEWS OF THE DRAWINGS

FIG. 1—Line drawings illustrating the data parameters transmitted between a client system (“CLI”) and server system (“APP”) corresponding to: Claims 1-7; Claims 1-4, 8-10; and claims 1, 11-14.

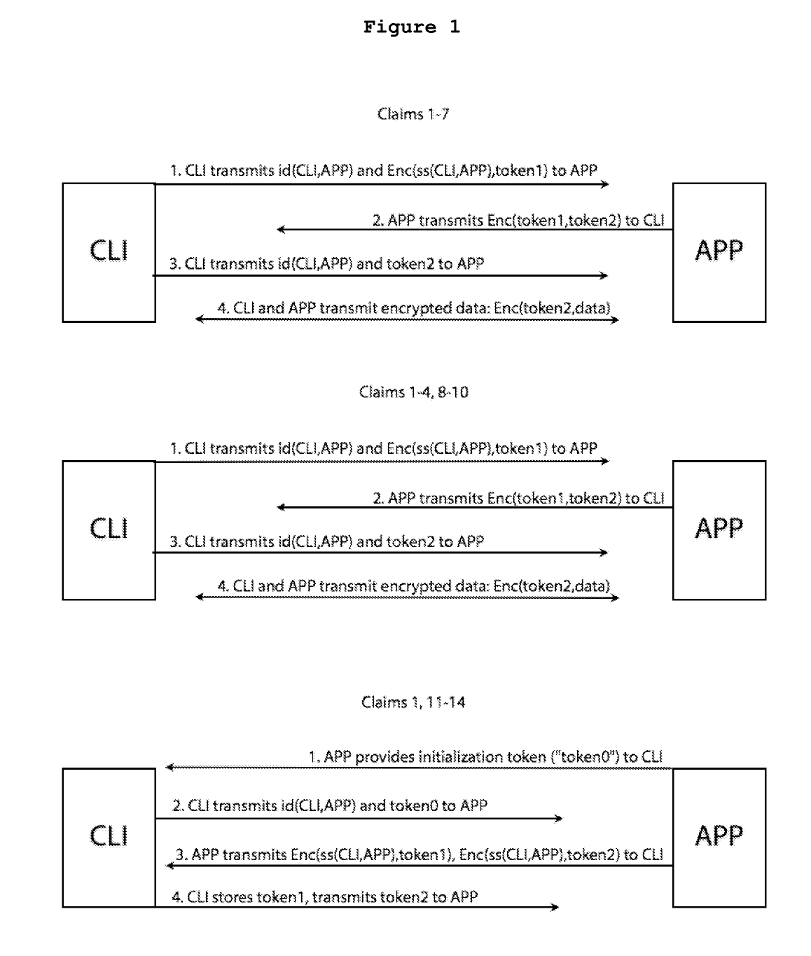

FIG. 2—Line drawing illustrating the data parameters transmitted between a client system (“CLI”), server system (“APP”), and trusted token system (“TTS”) corresponding to: Claims 15-21

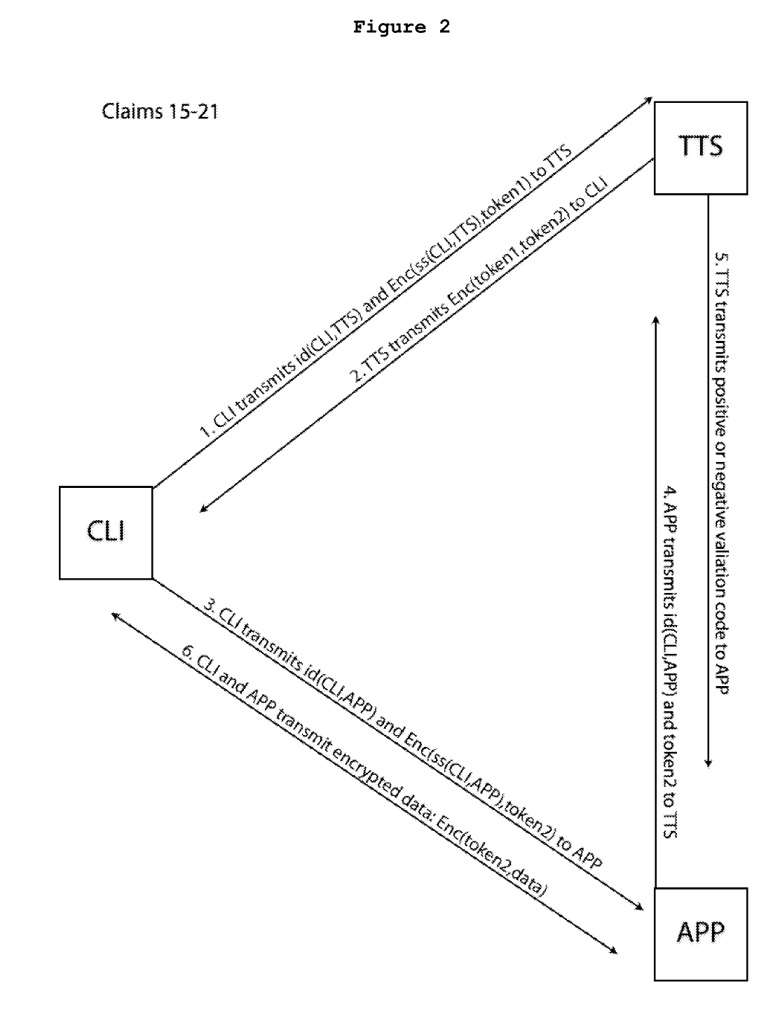

FIG. 3—Line drawing illustrating the data parameters transmitted between a client system (“CLI”), server system (“APP”), and trusted token system (“TTS”) corresponding to: Claims 15-19, 22-24

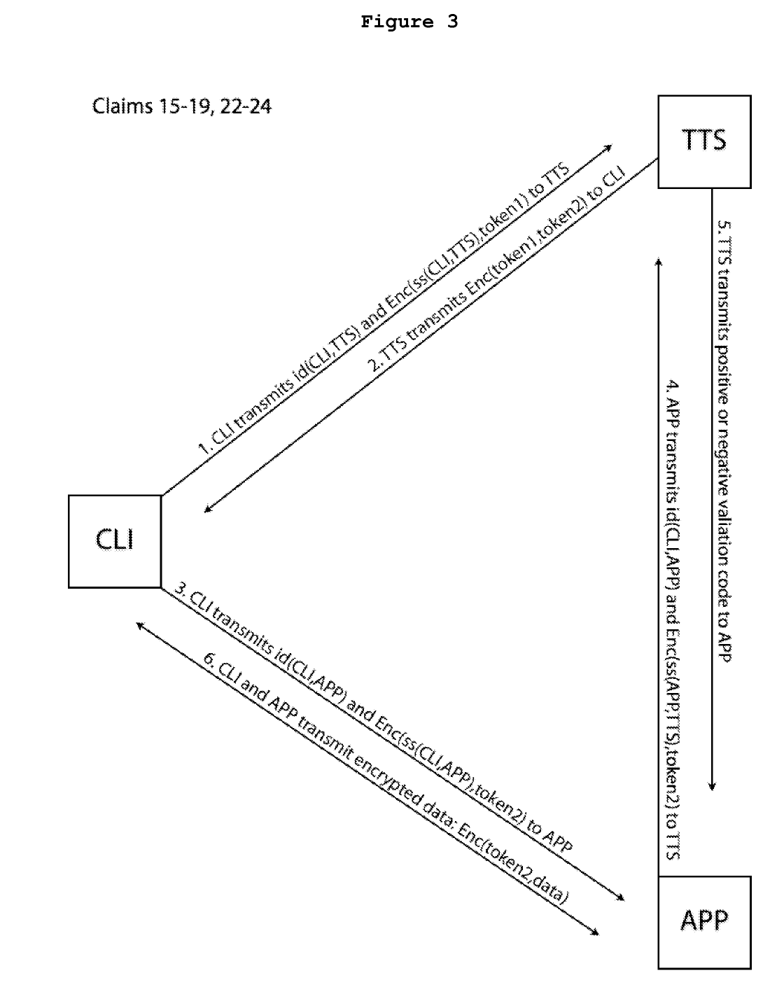

FIG. 4—Line drawing illustrating the data parameters transmitted between a client system (“CLI”), server system (“APP”), and trusted token system (“TTS”) corresponding to: Claims 15, 25-33

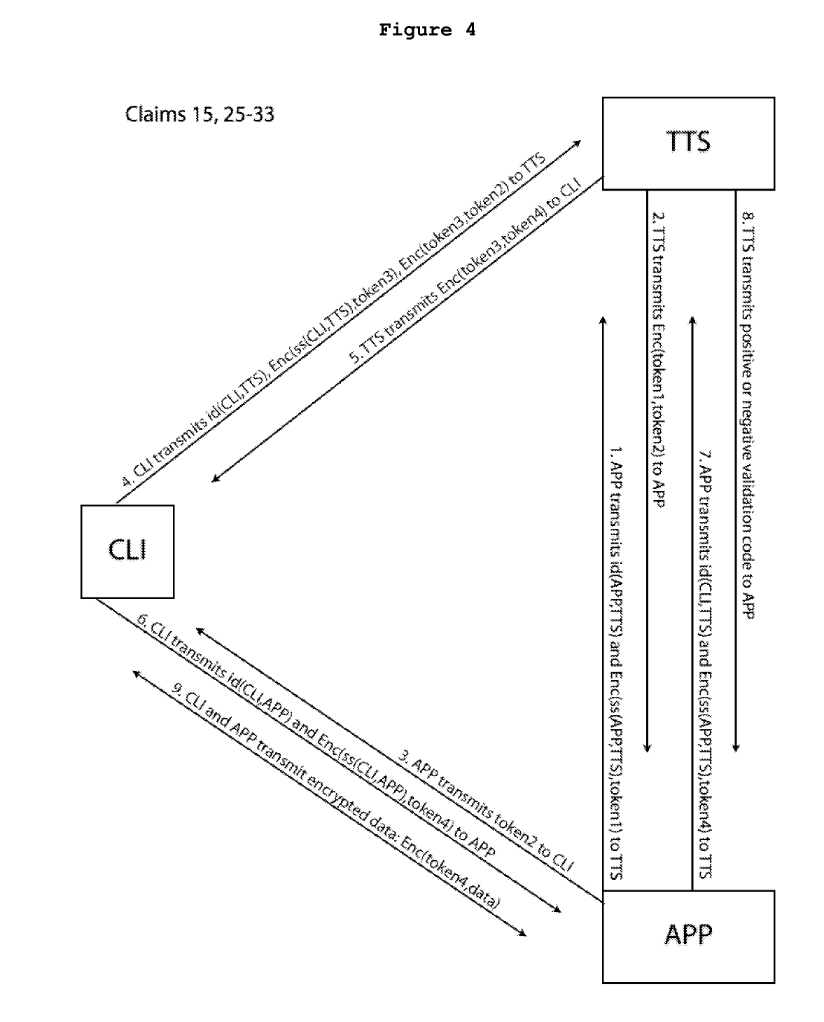

FIG. 5—Line drawing illustrating the data parameters transmitted between a client system (“CLI”), server system (“APP”), and trusted token system (“TTS”) corresponding to: Claims 15, 34. FIG. 5 illustrates the complete first round of data transmissions between the entities.

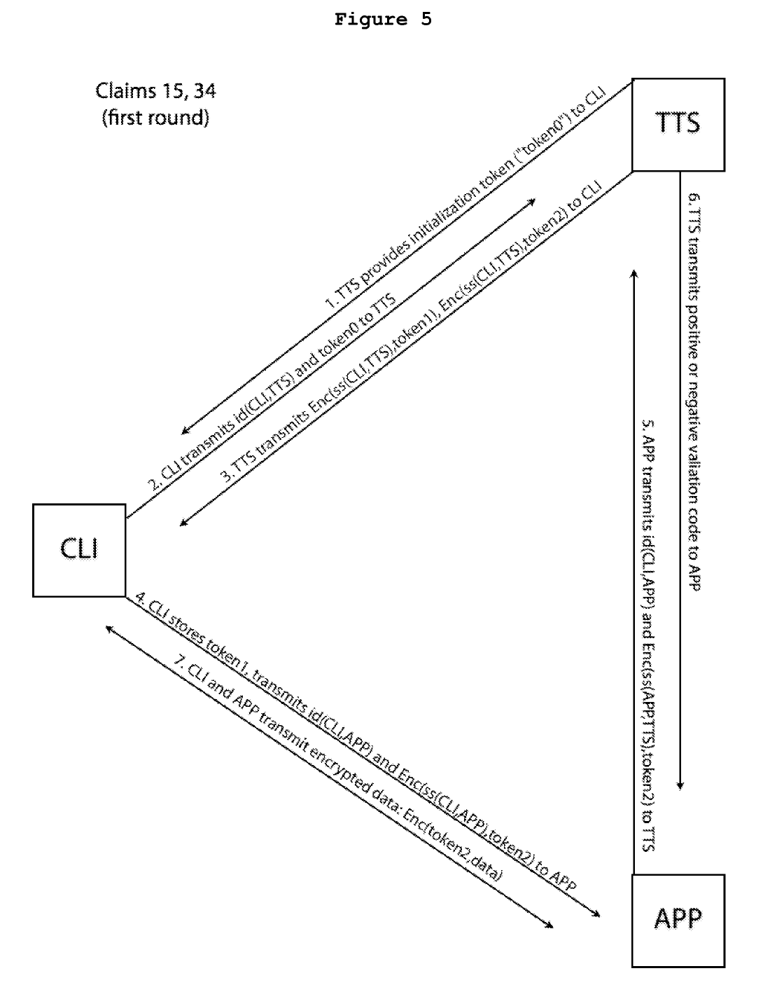

FIG. 6—Line drawing illustrating the data parameters transmitted between a client system (“CLI”), server system (“APP”), and trusted token system (“TTS”) corresponding to: Claims 15, 34. FIG. 6 illustrates the complete second round of data transmissions between the entities that logically would follow the first round as illustrated in FIG. 5.

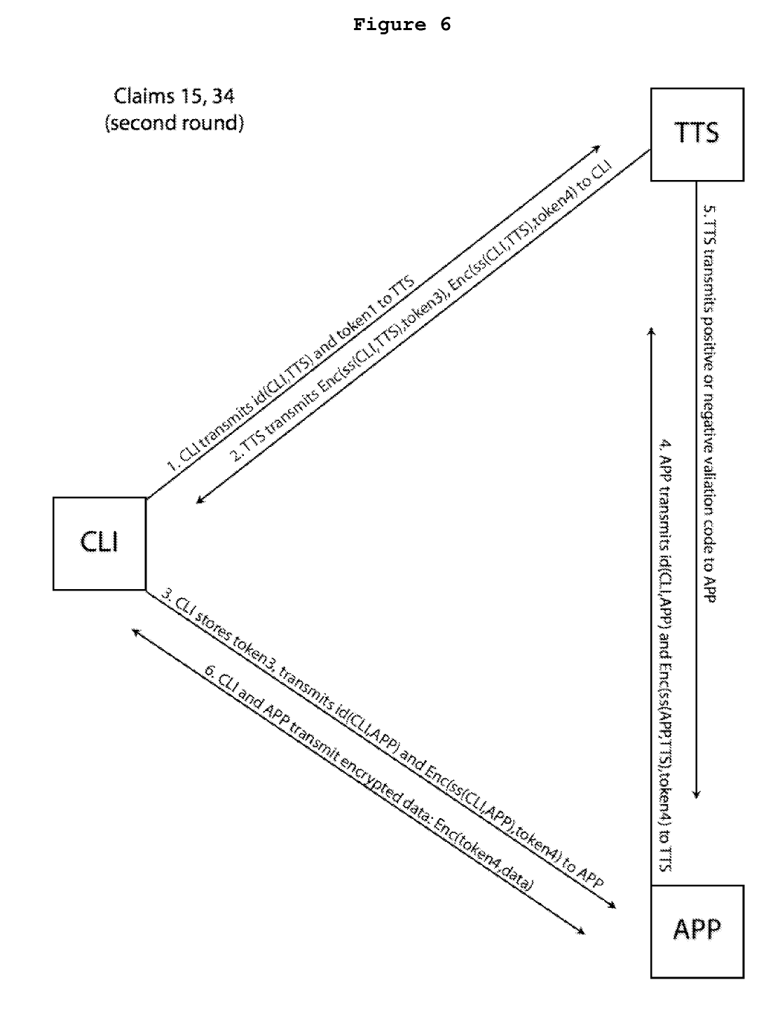

FIG. 7—Line drawings illustrating the data parameters transmitted between a client system (“CLI”) and server system (“APP”) corresponding to: Claims 1-3, 35-37. FIG. 7 illustrates both the first and second rounds of data transmissions between the entities wherein the second round logically would follow the first round.

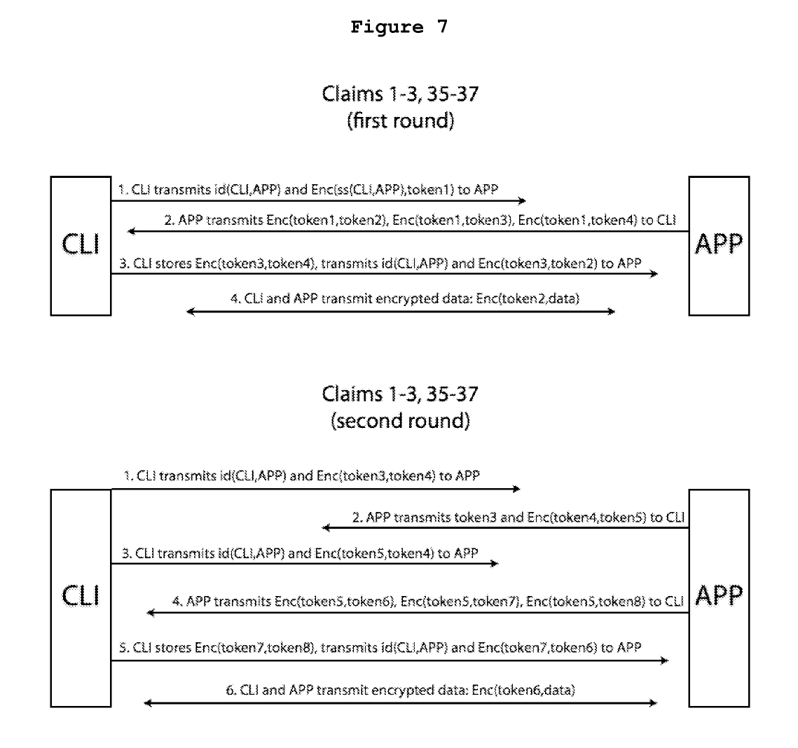

FIG. 8—Line drawing illustrating the data parameters transmitted between a client system (“CLI”), server system (“APP”), and trusted token system (“TTS”) corresponding to: Claims 15-17, 38-40. FIG. 8 illustrates the complete first round of data transmissions between the entities.

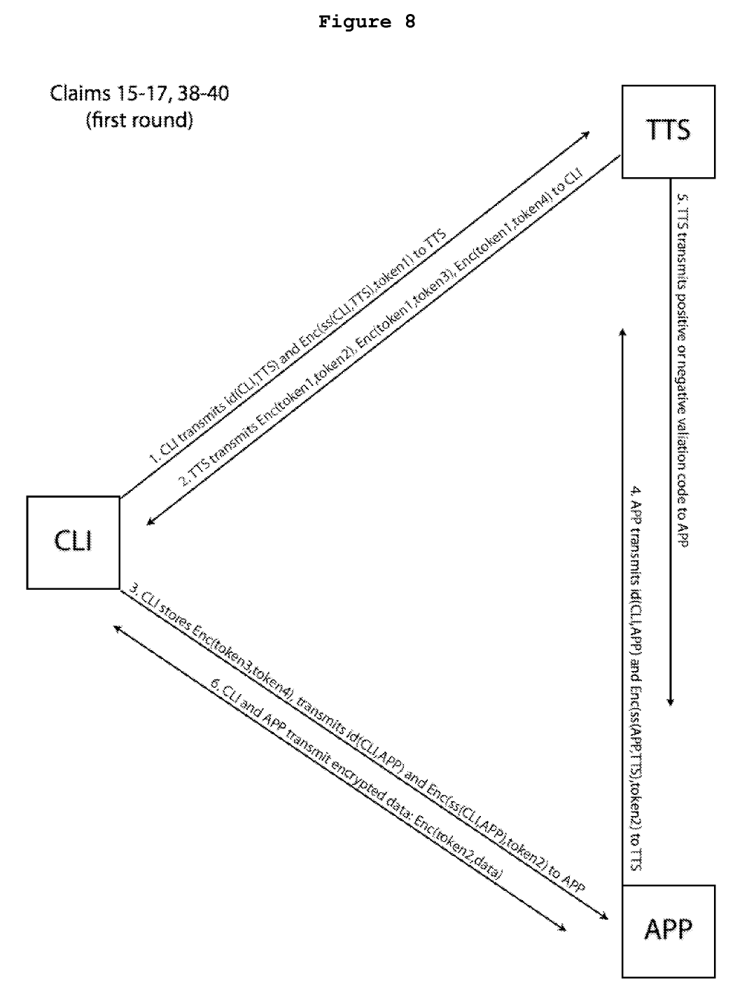

FIG. 9—Line drawing illustrating the data parameters transmitted between a client system (“CLI”), server system (“APP”), and trusted token system (“TTS”) corresponding to: Claims 15-17, 38-40. FIG. 9 illustrates the complete second round of data transmissions between the entities that logically would follow the first round as illustrated in FIG. 8.

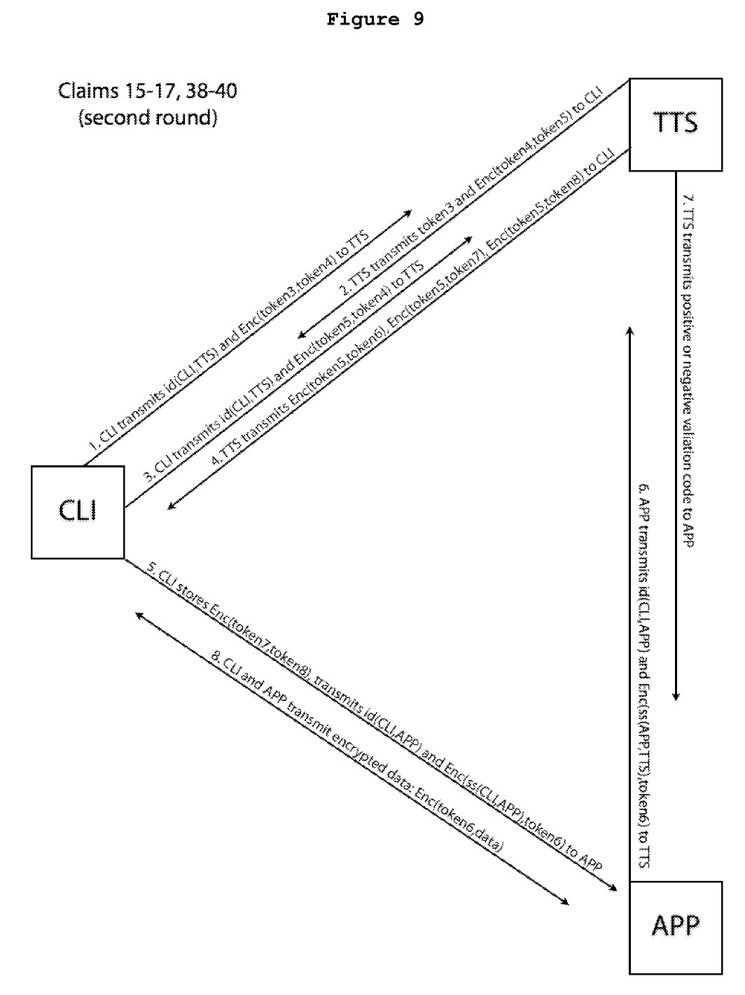

### DETAILED DESCRIPTION OF THE INVENTION

The invention describes a new method for entities to securely transmit data across insecure or untrusted data communications networks and verify the identity of other entities. This new method involves a shared secret known only to the entities, pseudo-randomly generated data values, and an encryption algorithm. The invention enables the entities to complete the desired functions without transmitting the shared secret after this shared secret has been established and agreed upon by the entities. Instead of an entity providing the shared secret to another entity for comparison, both entities will utilize the shared secret as an encryption and decryption key for the encryption algorithm, which will encrypt pseudo-random data values. Multiple (at least two) encryption-decryption processes utilizing varying encryption keys and pseudo-random data values are used to ensure that only those entities possessing the shared secret can determine the correct pseudo-random data values, which will then be used as an encryption key or authentication code (or both).

The entities must first established a shared secret known only to the entities and have access to the same encryption algorithm. Subsequently, one entity (first entity) can utilize this shared secret to encrypt a pseudo-random data value and then transmit the resulting encrypted data value (commonly referred to as “ciphertext”) to the other entity. The receiving entity (second entity) will utilize the same shared secret to decrypt the ciphertext in order to determine the pseudo-random data value. Note that an identification data value must accompany the ciphertext in order for the receiving entity to know which shared secret to use as the decryption key. The second entity will then utilize the first pseudo-random data value to encrypt a second pseudo-random data value, and then transmit the resulting ciphertext to the first entity. The first entity—being the only entity to know the first pseudo-random data value—can decrypt the ciphertext to determine the second pseudo-random data value, which can then be used as a one time use encryption key and authentication token.

As described above, the invention utilizes a symmetric (private key) encryption algorithm, shared secrets, and pseudo-randomly generated tokens to securely transmit sensitive data. Traditional authentication tokens, such as an account identifier and password, may be utilized to identify the requesting user and to securely transmit encryption and authentication tokens between three entities: two entities that desire to communicate securely, such as a client system (“CLI”) and a server system (“APP”), and a trusted token system (“TTS”). It should be noted that a user—a human, application, or other entity—may utilize one or more clients and that CLI refers to one or more client systems, which may consist of many variations of hardware and software.

The invention applies to and can be easily adapted to authentication methods other than the traditional user id and password tokens. Furthermore, a shared secret may actually comprise several types and variations of shared secrets. For example, a shared secret may be a combination of a password, a traditional one time use token value, and a fingerprint. Alternatively, multiple shared secrets could be used simultaneously and separately with the method of this invention. The symmetric encryption algorithm should provide reasonable protection against “known plaintext” attacks since true randomness cannot be guaranteed by many token generating algorithms. Similarly, the shared secrets should be reasonably complex to prevent attackers from easily guessing the shared secret for an entity. Encryption algorithms that utilize a dynamic or pseudorandom initialization vector may be used; however, the initialization vector must be known by or shared between the relevant entities.

In its most basic form, the invention may involve an authentication method in which a shared secret is utilized as an encryption key to securely transmit a one time password from one entity to another; for example, from CLI to APP. In this scenario, the TTS functionality may be provided by APP. More complex scenarios will involve separate and distinct APP and TTS systems, and the TTS functionality may optionally be provided by a third party in a “software as a service” model. The shared secret may be of one or more forms or types and may include one or more shared secrets, including but not limited to: password, passphrase, public key infrastructure certificate, challenge-response, fact or opinion based questionnaire, traditional one time use token, and fingerprint or other biometric data. The terms “client system” (CLI), “server system” (APP), and “trusted token system” (TTS) are utilized in the description and claims of this invention for illustrative purposes and do not limit the intended use or applicability of the invention. Moreover, CLI and APP may apply to any system, device, application, user, or other entity. The invention also applies to secure data transmission between two or more entities of any type as well as offline (no network connectivity) implementations of the method within a single system.

The invention is intended for use across a wide variety of applications and in virtually any or all systems. The invention may replace or supplement any existing authentication methods/algorithms, in addition to providing a method to share sensitive data that is both secure and easy to use. Popular web applications, such as those providing online banking, e-mail, and e-commerce functionality, would be good targets for implementing this new method since these applications have many users (or clients) that can use several different types and versions of web browsers (the client system). The new method could be either incorporated into the web applications' server-side functionality or through a software-as-a-service (SaaS) system, and the web application or SaaS system could provide each client system with the necessary functionality using HTML/JavaScript or other dynamic web browser technology.

The following definitions are also used in the example implementation processes below:
id(x,y)=account identification value for entity x configured in system y
ss(x,y)=shared secret known only to entities x and y
tokenx=token number x; x={0, 1, . . . }
Enc(x,y)=encryption of plaintext y using encryption key x
x|y=concatenation of data values x and y

The following processes describe the actions and data transmitted between three entities to allow APP to validate the identity of CLI using the invention described above. The following processes are intended to be example implementations of the SDT method of the invention to demonstrate how the invention may be utilized. Other processes and authentication or encryption methods may be developed or modified to incorporate the SDT method of this invention. Implementations of the invention may include variations from this process.

### Example Process 1

### MFA with Initialization

It is assumed that the CLI, APP, and TTS have already agreed upon authentication credentials with each other entity.
1. CLI->TTS: CLI requests from TTS to initialize the CLI as an approved system for authentication utilizing the new method described in this invention.
2. TTS->CLI: TTS responds to the CLI request as described in step 1 and requests identifying information to prove the CLI identity.
3. CLI->TTS: CLI transmits to TTS an account identifier, id(CLI,TTS), and a shared secret, ss(CLI,TTS), as requested by TTS in step 2 in order to request a new token.
4. TTS->CLI: TTS generates one pseudo-random token, token0, and sends the encrypted data value Enc(ss(CLI,TTS),token0) to CLI.
5. CLI->APP: CLI requests the APP login function.
6. APP->CLI: APP responds to CLI and transmits the APP login function.
7. CLI->TTS: CLI decrypts Enc(ss(CLI,TTS),token0) to determine token0 and transmits id(CLI,TTS) and token0 to TTS.
8. TTS->CLI: TTS compares token0 sent by CLI in step 7 to token0 generated by TTS and sent to CLI in step 4. If the two data values are equal, TTS generates two pseudo-random tokens, token1 and token2, concatenates them to form a single data value, token1|token2, and sends the encrypted data value Enc(ss(CLI,TTS),token1|token2) to CLI. Otherwise, TTS sends any pseudo-random value (junk or throwaway data) to CLI.
9. CLI->APP: CLI decrypts Enc(ss(CLI,TTS),token1|token2) to determine token1 and token2, stores Enc(ss(CLI,TTS),token1), and transmits id(CLI,APP), ss(CLI,APP), and token2 to APP.
10. APP->TTS: APP transmits id(APP,TTS), id(CLI,APP), and token2 to TTS.
11. TTS->APP: TTS matches id(APP,TTS) and id(CLI,APP) to determine id(CLI,TTS), and then compares token2 sent by APP in step 10 for id(CLI,APP) to token2 sent by TTS for id(CLI,TTS) in step 8. If the two values are identical, then TTS responds to APP with a positive validation code; otherwise, TTS responds to APP with a negative validation code.
12. APP->CLI: If TTS sends a positive validation code in step 11, APP validates id(CLI,APP) and ss(CLI,APP) sent by CLI in step 9 to complete the authentication. APP sends a positive or negative authentication message to CLI based on the results of the token2 comparison in step 11 and the id(CLI,APP) and ss(CLI,APP) validation in this step.
Steps 5-12 will be repeated for additional CLI authentication attempts.

### Example Process 2

### MFA without Initialization

It is assumed that CLI, APP, and TTS have already agreed upon authentication credentials with each other entity.
1. CLI->TTS: CLI requests from TTS to create a new user account, id(CLI,TTS).
2. TTS->CLI: TTS responds to the CLI request in step 1 and requests identifying information to prove the CLI identity.
3. CLI->TTS: CLI transmits to TTS an account identifier, id(CLI,TTS), and a shared secret, ss(CLI,TTS), as requested by TTS in step 2 to complete the user creation subprocess.
4. CLI->APP: CLI requests the APP login function.
5. APP->CLI: APP responds to CLI and transmits the APP login function.
6. CLI->TTS: CLI generates a new string of pseudo-random characters (“token”), token0, stores token0 in temporary storage, and transmits id(CLI,TTS) and Enc(ss(CLI,TTS),token0) to TTS.
7. TTS->CLI: If no account associated with id(CLI,TTS) is known to TTS, then junk data (pseudo-random string) will be returned to CLI. Otherwise, TTS determines token0 by decrypting Enc(ss(CLI,TTS),token0) with the shared secret ss(CLI,TTS) stored in the id(CLI,TTS) account. TTS then generates a pseudo-random token, token1, and sends the encrypted data value Enc(token0,token1) to CLI.
8. CLI->APP: CLI decrypts Enc(token0,token1) to determine token1 and transmits id(CLI,APP), ss(CLI,APP), and token1 to APP.
9. APP->TTS: APP transmits id(CLI,APP), id(APP,TTS), and token1 to TTS for validation.
10. TTS->APP: TTS matches id(APP,TTS) and id(CLI,APP) to determine id(CLI,TTS), and then compare token1 sent by APP in step 9 for id(CLI,APP) to token1 sent by TTS for id(CLI,TTS) in step 7. If the two values are identical, then TTS responds to APP with a positive validation code; otherwise, TTS responds to APP with a negative validation code.
11. APP->CLI: If TTS sent a positive validation code in step 10, APP validates id(CLI,APP) and ss(CLI,APP) sent by CLI in step 9 to complete the authentication. APP sends a positive or negative authentication message to CLI based on the results of the token1 comparison in step 10 and the id(CLI,APP) and ss(CLI,APP) validation in this step.
Steps 4-11 will be repeated for additional CLI authentication attempts.

The following example process illustrates the data communication between CLI, APP, and TTS (MFA without initialization). This example utilizes the Block TEA (Tiny Encryption Algorithm) encryption algorithm and the following sample data values listed below. The encrypted data values were obtained utilizing the HTML/JavaScript implementation of Block TEA from the web site “http://www.movable-type.co.uk/scripts/tea-block.html” on Jan. 5, 2011. This encryption algorithm and sample values were selected for illustrative purposes and are not a part of the invention.

id(CLI,TTS)=johndoe@tts.domain
ss(CLI,TTS)=$trong P@ssw0rd
id(CLI,APP)=john.doe@app.domain
ss(CLI,APP)=SimplePassword123
ss(APP,TTS)=ojFJ;jrow;r89ur802u*R*@(R749
token1=p$Fw}duSgYSB̂6[s″#(y
Enc(ss(CLI,TTS),token1)=jAzyktUK9KFlQFkVnonMFqVU9C8=
token2=PERE3:cz′[r6E8Xsn&q8
Enc(token1,token2)=YuClzEcM1za1FluRM319bAgW2D8=
Enc(ss(CLI,APP),token2)=kYJ4XS6Ydw5Uto7VqNLwvs6/KwM=
Enc(ss(APP,TTS),token2)=E3xzNV3BnZU2l+HU0yssttVBKt8=
Secret-data-string=Hello John Doe! You have successfully authenticated.
Enc(ss(CLI,APP),Secret-data-string)=LVseB86fveZ1kGYQXI/RMIsQG/6ydozJ5KRDBq5QbayQexbBOyD6vtvsjs6HiofgHJPKLw==
The sample data values listed above are shown between double quote characters (“) immediately following the data parameter name in the steps below if that data value is transmitted to another entity. For example, the CLI identifier configured with TTS will be listed as follows:
id(CLI,TTS) “johndoe@tts.domain”
   Each sample data value will be included only once in the steps below.
   1. CLI generates token1, then transmits id(CLI,TTS) “johndoe@tts.domain” and Enc(ss(CLI,TTS),token1) “jAzyktUK9KFlQFkVnonMFqVU9C8=” to TTS.
   2. TTS decrypts Enc(ss(CLI,TTS),token1) to determine token1, generates token2, then transmits Enc(token1,token2) “YuClzEcM1za1FluRM319bAgW2D8=” to CLI.
   3. CLI decrypts Enc(token1,token2) to determine token2, then transmits id(CLI,APP) “john.doe@app.domain” and Enc(ss(CLI,APP),token2) “kYJ4XS6Ydw5Uto7VqNLwvs6/KwM=” to APP.
   4. APP decrypts Enc(ss(CLI,APP),token2) to determine token2, then transmits id(CLI,APP) “john.doe@app.domain” and Enc(ss(APP,TTS),token2) “E3xzNV3BnZU2I+HU0yssttVBKt8=” to TTS.
   5. TTS matches id(CLI,APP) to id(CLI,TTS), decrypts Enc(ss(APP,TTS),token2) to determine token2, compares to the original token2 value generated by TTS in step 2 above, then transmits a positive validation code to APP (assuming the values are equal).
   6. Assuming HS transmitted a positive validation code, APP authenticates CLI as id(CLI,APP), then transmits Enc(token2,Secret-data-string) “LVseB86fveZ1kGYQXI/RMIsQG/6ydozJ5KRDBq5QbayQexbBOyD6vtvsjs6HiofgHJPKLw==” to CLI.
   7. CLI decrypts Enc(token2,Secret-data-string) to determine Secret-data-string. The authenticated session between CLI and APP may then continue and each entity may utilize token2 as an encryption key to encrypt additional sensitive data values.

What is claimed is:

1. A secure data transmission method for use in connection with potentially untrusted systems and data communication networks comprising two entities: (1) a client system that communicates with (2) a server system. The client system may comprise any hardware device(s) and software application(s) interacting with a server system via network communication. The server system may comprise any hardware device(s) and software application(s) that provide authorized client systems with access to data and functionality via network communication. The secure data transmission method involves a shared secret—known to both the client and server systems—as an encryption key for an encryption algorithm to encrypt a data string composed of pseudo-random characters (a “token”). The encrypted first token is transmitted by the sending entity and then received by the other entity. The receiving entity can decrypt the transmitted value (encrypted first token) utilizing the same shared secret in order to determine the first token and then utilize the first token as an encryption key for an encryption algorithm to encrypt a second token. The receiving entity will then respond to the sending entity with the value of the encrypted second token. Since the second token could only be determined by an entity with access to the first token and thus the shared secret, the second token can be known only by the sending and receiving entities that know the shared secret, and thus the second token can be used as an encryption key and/or as an authentication code by the two entities.

2. The secure data transmission method of claim 1 wherein the client system utilizes a shared secret as an encryption key for an encryption algorithm to encrypt a token, “token1”, and then transmits the encrypted data string and an account identification value associated with the shared secret to the server system.

3. The secure data transmission method of claim 2 wherein the server system utilizes the shared secret described in claim 2 to decrypt the encrypted data string sent by the client system to determine token1 and utilizes token1 as an encryption key for an encryption algorithm to encrypt a second token, “token2”, and then transmits the encrypted data string to the client system.

4. The secure data transmission method of claim 3 wherein the client system utilizes token1—as described in claim 2—to decrypt the encrypted data string sent by the server system to determine token2 as described in claim 3.

5. The secure data transmission method of claim 4 wherein the client system and server system utilize token2 as an encryption key for an encryption algorithm to securely transmit data between the two entities.

6. The secure data transmission method of claim 4 wherein the client system and server system utilize token2 as a token for an authentication function to validate the identity of the client system to the server system. The client system transmits token2 to the server system for verification.

7. The secure data transmission method of claim 6 wherein the server system compares the token2 value sent by the client system as described in claim 6 to the token2 value created by the server system as described in claim 3. If the values are equal, the client system is successfully authenticated as the entity associated with the account identification value sent by the client system as described in claim 2.

8. The secure data transmission method of claim 4 wherein the client system utilizes the shared secret—as described in claim 1—as an encryption key for an encryption algorithm to encrypt token2—as described in claim 3—and then transmits the encrypted data string and an account identification value associated with the shared secret to the server system.

9. The secure data transmission method of claim 8 wherein the server system utilizes the shared secret—as described in claim 8—to decrypt the encrypted data string sent by the client system to validate that the client system transmitted the same value for token2 that was created by the server system as described in claim 3.

10. The secure data transmission method of claim 9 wherein the client and server systems utilize token2—as described in claim 3—as an encryption key to encrypt sensitive data for secure transmission between the client and server systems if and only if the client transmitted—as described in claim 9—the same value for token2 that was created by the server system as described in claim 3.

11. The secure data transmission method of claim 1 wherein the client system and server system establish an initial token, “token0”, known only to the client and server systems, to be used as an initialization value for the client system. This initialization token (“token0”) will be used by the client system to prove its identity to the server system as part of an authentication and/or encryption process.

12. The secure data transmission method of claim 11 wherein the client system transmits the initialization value, “token0”, with or without an account identification value, to the server system to initiate a new authentication and/or encryption process.

13. The secure data transmission method of claim 12 wherein the server system compares the initialization value sent by the client system as described in claim 12 to the initial token value as described in claim 11. If the values are equal, the server system utilizes a shared secret known only to the client and server systems to encrypt two new tokens, “token1” and “token2”, and transmits the encrypted value(s) to the client system. These tokens may optionally be encrypted and transmitted as separate values or they may be first combined into a single value and then encrypted and transmitted as a single value (the client system must know how to separate the values if they are combined and sent as a single value). Either option is acceptable and has no affect on the claims of the invention.

14. The secure data transmission method of claim 13 wherein the client system utilizes the shared secret—as described in claim 13—to decrypt the encrypted values sent by the server system as described in claim 13 to determine token1 and token2. The client system stores token1—optionally in an encrypted format—to be used as an initialization value by the client system and server system in future authentication and/or encryption processes. The client system and server system then utilize token2 as an encryption key for an encryption algorithm to securely transmit data between the two entities and/or as a token for an authentication function to validate the identity of the client system to the server system.

15. A secure data transmission method for use in connection with potentially untrusted systems and data communication networks comprising three or more entities: (1) a client system that communicates with (2) a server system, and (3) at least one trusted token system that facilitates authentication and secure communication of data transmitted between the client system and server system. The client system may comprise any hardware device(s) and software application(s) interacting with server and trusted token systems via network communication. The server system may comprise any hardware device(s) and software application(s) that interact with client and trusted token systems and provide authorized client systems with access to data and functionality via network communication. The trusted token system(s) may comprise any hardware device(s) and software application(s) utilized by client and server systems to: (i) generate a token comprising characters generated with an algorithm designed to produce, as a result, random or pseudo-random characters; (ii) securely transmit said token to both or either of the client system and server system; (iii) validate, on behalf of a server system, a token transmitted by a client system; and (iv) validate, on behalf of a client system, a token transmitted by a server system. The secure data transmission method involves a shared secret—known to at least two of the systems described above—as an encryption key for an encryption algorithm to encrypt a token. The encrypted first token is transmitted by the sending entity and then received by another entity. The receiving entity can decrypt the transmitted value (encrypted first token) to determine the first token and then utilize the first token as an encryption key for an encryption algorithm to encrypt a second token. The receiving entity will then respond to the sending entity with the value of the encrypted second token. Since the second token could only be determined by an entity with access to the first token and thus the shared secret, the second token can be known only by the sending and receiving entities that know the shared secret, and thus the second token can be used as an encryption key and/or as an authentication code by the two entities.

16. The secure data transmission method of claim 15 wherein the client system utilizes a shared secret—known only to the trusted token system and the client system—as an encryption key for an encryption algorithm to encrypt a token, “token1”, and then transmits the encrypted data string and an account identification value associated with the shared secret to the trusted token system.

17. The secure data transmission method of claim 16 wherein the trusted token system utilizes the shared secret described in claim 16 to decrypt the encrypted data string sent by the client system to determine token1 and then utilizes token1 as an encryption key for an encryption algorithm to encrypt a second token, “token2”, and then transmits the encrypted data string to client system.

18. The secure data transmission method of claim 17 wherein the client system utilizes token1—as described in claim 16—to decrypt the encrypted data string sent by the trusted token system to determine token2.

19. The secure data transmission method of claim 18 wherein the client system utilizes a shared secret—known only to the client system and the server system—as an encryption key for an algorithm to encrypt token2 and then transmits the encrypted data string and an account identification value associated with the shared secret to the server system.

20. The secure data transmission method of claim 19 wherein the server system utilizes the shared secret described in claim 19 to decrypt the encrypted data string sent by the client system to determine token2 and then transmits the decrypted data value—which is equal to token2 if the client system utilized the correct shared secret described in claims 16 and 19—to the trusted token system in order to validate that the client system transmitted the same second token (token2) that was created by the trusted token system as described in claim 17. The trusted token system will respond to the server system by transmitting a positive or negative validation code to indicate the token is valid or invalid for said client.

21. The secure data transmission method of claim 20 wherein the client and server systems utilize token2 as an encryption key for an encryption algorithm to securely transmit data between the two entities and/or as a token for an authentication function to validate the identity of the client system to the server system if and only if the client system transmitted the correct second token (token2) as described in claim 19.

22. The secure data transmission method of claim 19 wherein the server system utilizes the shared secret described in claim 19 to decrypt the encrypted data string sent by the client system to determine token2 and then utilizes a shared secret—known only to the trusted token system and the server system—as an encryption key for an encryption algorithm to encrypt token2—as described in claim 19—and then transmits the encrypted data string and an account identification value associated with the shared secret to the trusted token system.

23. The secure data transmission method of claim 22 wherein the trusted token system utilizes the shared secret described in claim 22 to decrypt the encrypted data string sent by the server system to determine token2—as described in claim 22—to validate that the client system transmitted the same second token (token2), which was created by the trusted token system as described in claim 17, to the server system as described in claim 19. The trusted token system transmits a positive or negative validation code to the server system in order to indicate the second token transmitted by the client system is valid or invalid; the validation code may be encrypted by the trusted token system—and subsequently decrypted by the server system—utilizing the shared secret described in claim 22 as the encryption key.

24. The secure data transmission method of claim 23 wherein the client and server systems utilize token2 as an encryption key for an encryption algorithm to securely transmit data between the two entities and/or as a token for an authentication function to validate the identity of the client system to the server system if and only if the client transmitted the correct second token (token2) as described in claim 19.

25. The secure data transmission method of claim 15 wherein the server system utilizes a shared secret—known only to the server system and the trusted token system—as an encryption key for an encryption algorithm to encrypt a token, “token1”, and then transmits the encrypted data string and an account identification value associated with the shared secret to the trusted token system.

26. The secure data transmission method of claim 25 wherein the trusted token system utilizes the shared secret described in claim 25 to decrypt the encrypted data string sent by the server system to determine token1 and then utilizes token1 as an encryption key for an encryption algorithm to encrypt a second token, “token2”, and then transmits the encrypted data string to the server system.

27. The secure data transmission method of claim 26 wherein the server system utilizes token1—as described in claim 25—to decrypt the encrypted data string sent by the trusted token system to determine token2 and then transmits token2 to the client system.

28. The secure data transmission method of claim 27 wherein the client system utilizes a shared secret—known only to the client system and the trusted token system—as an encryption key for an encryption algorithm to encrypt a third token, “token3”, then utilizes token3 as an encryption key for an encryption algorithm to encrypt token2, and then transmits both encrypted data strings and an account identification value associated with the shared secret to the trusted token system.

29. The secure data transmission method of claim 28 wherein the trusted token system utilizes the shared secret described in claim 28 to decrypt the first encrypted data string transmitted by the client system to determine token3, then utilizes token3 described in claim 28 to decrypt the second encrypted data string transmitted by the client system to validate the client system transmitted the same second token (token2) that was created by the trusted token system as described in claim 26. If the second token transmitted by the client system is not equal to the second token that was created by the trusted token system as described in claim 26, then the trusted token system transmits a negative validation code to the client system. If the second token transmitted by the client system is equal to the second token that was created by the trusted token system as described in claim 26, then the trusted token system utilizes token3 as an encryption key for an encryption algorithm to encrypt a fourth token, “token4”, and then transmits the encrypted data string to the client system.

30. The secure data transmission method of claim 29 wherein the client system utilizes token3—as described in claim 28—to decrypt the encrypted data string sent by the trusted token system to determine token4. If a negative validation code was transmitted by the trusted token system—as described in claim 29—then the client system may discontinue all data transmissions with the server system since the server system did not transmit a valid token (token2) to the client system as described in claim 27.

31. The secure data transmission method according to claim 30 wherein the client system utilizes a shared secret—known only to the client system and the server system—as an encryption key for an encryption algorithm to encrypt token4 and then transmits the encrypted data string and an account identification value associated with the shared secret to the server system.

32. The secure data transmission method of claim 31 wherein the server system utilizes the shared secret described in claim 31 to decrypt the encrypted data string sent by the client system to determine token4 and then utilizes a shared secret known only to the server system and trusted token system as an encryption key for an encryption algorithm to encrypt the decrypted data value—which is equal to token4 if the client system utilized the correct shared secret described in claims 28 and 31—and transmits the encrypted data string to the trusted token system in order to validate the client system transmitted the same fourth token (token4) that was created by the trusted token system as described in claim 29. The trusted token system transmits a positive or negative validation code to the server system to indicate the fourth token transmitted by the client system is valid or invalid; the validation code may be encrypted by the trusted token system—and subsequently decrypted by the server system—utilizing a shared secret known only to the trusted token system and server system as the encryption key.

33. The secure data transmission method of claim 32 wherein the client and server systems utilize token4 as an encryption key for an encryption algorithm to securely transmit data between the two entities and/or as a token for an authentication function to validate the identity of the client system to the server system if and only if the client transmitted the correct fourth token (token4) to the server system as described in claim 31.

34. The secure data transmission method of claim 15 wherein the client system and trusted token system establish an initial token known only to the client and trusted token systems, to be used as an initialization value for the client system. This initialization token will be used by the client system to prove its identity to the trusted token system as part of an authentication and/or encryption process. The server system and trusted token system may also establish an initial token known only to the server and trusted token systems to be used as an initialization value for the server system. This initialization token will be used by the server system to prove its identity to the trusted token system as part of an authentication and/or encryption process. The client system and/or server system may then initiate an authentication and/or encryption process similar to the processes described in claims 16 through 33 by providing the initialization token to the trusted token system to prove their respective identities and receive a new token in response from the trusted token system.

35. The secure data transmission method of claim 3 wherein the server system utilizes token1—as described in claim 2—as an encryption key for an encryption algorithm to encrypt two additional tokens, “token3” and “token4”, and then transmits the encrypted data string to the client system.

36. The secure data transmission method of claim 35 wherein the client system utilizes token1 to decrypt the encrypted data string sent by the server system to determine token3 and token4, and then utilizes token3 as an encryption key for an encryption algorithm to encrypt token4. The resulting encrypted data string will be stored for a future authentication process. The client system then discards the data values denoted as token3 and token4.

37. The secure data transmission method of claim 36 wherein the client system requests token3 from the server system in order to decrypt the encrypted data string—as described in claim 36—to determine token4. The server system provides token3 to the client system, the client system decrypts the encrypted data string to determine token4, and then the client system transmits token4 to the server system. The client system and server system may utilize token4 as an authentication code in order to authenticate the client system without requiring the use of a shared secret. The client system may optionally transmit—along with a user identification value—the encrypted data string formed by utilizing token3 as an encryption key for an encryption algorithm to encrypt token4. The server system would then validate the client system provided the correct value for this encrypted data string before providing token3 to the client system.

38. The secure data transmission method of claim 17 wherein the trusted token system utilizes token1—as described in claim 16—as an encryption key for an encryption algorithm to encrypt two additional tokens, “token3” and “token4”, and then transmits the encrypted data string to the client system.

39. The secure data transmission method of claim 38 wherein the client system utilizes token1 to decrypt the encrypted data string sent by the trusted token system to determine token3 and token4, and then utilizes token3 as an encryption key for an encryption algorithm to encrypt token4. The resulting encrypted data string will be stored for a future authentication process. The client system then discards the data values denoted as token3 and token4.

40. The secure data transmission method of claim 39 wherein the client system requests token3 from the trusted token system in order to decrypt the encrypted data string—as described in claim 39—to determine token4. The trusted token system provides token3 to the client system, the client system decrypts the encrypted data string to determine token4, and then the client system transmits token4 to the trusted token system. The client system and trusted token system may utilize token4 as an authentication code in order to authenticate the client system without requiring the use of the shared secret.
